(19) United States
(12) Patent Application Publication
(10) Pub. No.: US 2020/0171741 A1
(43) Pub. Date: Jun. 4, 2020

(54) 3D PRINTER AND 3D PRINTING METHOD AND 3D PRINTER CONTROL PROGRAM

(71) Applicant: Foundation for Research and Business, Seoul National University of Science and Technology, Seoul (KR)

(72) Inventors: Sangjo HAN, Seoul (KR); Jong Beom SEO, Seoul (KR); Youngseok KANG, Seoul (KR); Hyoungchul KIM, Seoul (KR); Sang Hyuk WOO, Cheonan-si Chungcheongnam-do (KR)

(21) Appl. No.: 16/614,035

(22) PCT Filed: Apr. 10, 2018
(86) PCT No.: PCT/KR2018/004211

§ 371 Date: Jan. 29, 2020

(30) Foreign Application Priority Data
May 15, 2017 (KR) 10-2017-0059871

(51) Int. Cl. B29C 64/129; B33Y 10/00; B33Y 30/00; B33Y 50/02; B29C 64/393

(52) U.S. Cl. CPC B29C 64/129; B33Y 10/00; B29C 64/393; B33Y 50/02; B33Y 30/00

(57) ABSTRACT

When forming a three-dimensional object by laminating a plurality of cross-sectional layers, a 3D printer, a 3D printing method, and a 3D printer control program, according to one embodiment of the present invention, can improve the surface resolution of the three-dimensional object by dividing a cross-sectional layer into a plurality of cross-sectional images and using the same in order to form the cross-sectional layer.

### TECHNICAL FIELD

The present invention relates to a 3D printer, a 3D printing method and a 3D printer control program. More particularly, the present invention relates to a 3D printer, a 3D printing method and a 3D printer control program can improve the surface resolution of a 3D object.

### BACKGROUND ART

A digital light processing (DLP) type 3D printer achieves layered modeling by converting a 3D digital image for a 3D object into 2D images representing cross sections of the 3D object and irradiating the light corresponding to the 2D images into a photocurable resin to form cross-sectional layers.

The DLP type 3D printer enables modeling with a higher resolution than other types of 3D printers. In addition, the DLP type 3D printer easily outputs a 3D object using a wax-based photocurable polymer resin capable of casting. Therefore, the DLP type 3D printer can be widely used in fields of industrial applications requiring precision casting for use in, for example, jewelry, figure modeling, dental and medical materials, and turbine blades.

However, the DLP type 3D printer may demonstrate a staircase-like shape on the surface of a completed 3D object due to the thickness of a layered cross section, as shown in FIG. 1. Therefore, in a case where a high surface resolution is required, a postprocessing for smoothing the surface should be performed.

To address the issue, attempts at more finely forming a 2D image representing the cross section of a 3D object and reducing a height of a cross-sectional layer may be made, thereby reducing the surface roughness of the completed 3D object.

However, such attempts may increase the number of processing steps and may drastically increase an output time until the 3D object is completed.

In addition, even if the height of the cross-sectional layer is reduced, it is not possible to form a cross-sectional layer at a smaller spacing than a minimum physical spacing due to mechanical limitation of the 3D printer.

### Technical Problems to be Solved

An objective of the present invention is to provide a 3D printer, a 3D printing method and a 3D printer control program, which can improve the surface resolution of a 3D object.

Another objective of the present invention is to provide a 3D printer, a 3D printing method and a 3D printer control program, by which an output time is not increased until a 3D object is completed while improving the surface resolution of the 3D object.

Another objective of the present invention is to provide a 3D printer, a 3D printing method and a 3D printer control program, which can laminate a cross-sectional layer having a smaller height than a minimum physical spacing of the 3D printer, and can improve the surface resolution of a 3D object can be improved without a need to replace or remodel the mechanical configuration of the 3D printer.

### Technical Solutions

The above and other objectives of the present invention can be accomplished by providing the 3D printer, the 3D printing method and the 3D printer control program, according to the present invention.

The 3D printer according to an embodiment of the present invention may include an image providing unit, a light irradiation unit, a tank, a moving unit and a control unit.

The image providing unit may provide a plurality of cross-sectional images for a 3D object.

The light irradiation unit may irradiate light corresponding to the plurality of cross-sectional images provided by the image providing unit.

The tank may contain a photocurable resin therein and may receive the light from the light irradiation unit.

The moving unit may move the photocurable resin cured by means of the light by as much as a height of one cross-sectional layer.

The control unit may control the image providing unit, the light irradiation unit and the moving unit, and may control the image providing unit to provide a series of M cross-sectional images for the 3D object between an Nth movement and an (N+1)th movement of the moving unit. Here, N is an integer of 0 or greater, and M is an integer of 2 or greater.

When the displacement of the (N+1)th movement of the moving unit is L, the cross-sectional images may be obtained by dividing the 3D object by a spacing of L/M.

The control unit may control the light irradiation unit such that pixels corresponding to each of the M cross-sectional images sequentially irradiate the light with a same duration. Here, the light irradiation unit may irradiate the light with the same intensity to all areas of the cross-sectional images.

In addition, the control unit may control the light irradiation unit such that pixels corresponding to each of the M cross-sectional images irradiate the light with a different intensity and a different duration.

The image providing unit may provide superimposed images produced by superimposing the M images one above another.

The light irradiation unit may irradiate light from pixels into all areas of the superimposed images for the same period of time. Here, each pixel of the light irradiation unit may irradiate light with an intensity in proportion to the number of superimposed images.

Each of M cross-sectional images may have a different boundary line positioned at different pixels each other. When all of the M cross-sectional images have a same boundary lines positioned at the same pixel, the boundary lines of each of the images may have different color each other.

A 3D printing method according to an embodiment of the present invention is a method for forming a 3D object by repeating the step of forming a cross-sectional layer using the 3D printer.

The 3D printing method according to an embodiment of the present invention may include a step of providing a photocurable resin, a step of providing a plurality of images, a step of irradiating light.

The step of providing a photocurable resin is a step of providing a photocurable resin to form a cross-sectional layer.

The step of providing a plurality of images is a step of providing a series of M cross-sectional images for the 3D object to a light irradiation unit, where M is an integer of 2 or greater.

The step of irradiating light is a step of irradiating light corresponding to each of the M cross-sectional images to the photocurable resin.

The M cross-sectional images may be sequentially provided in the step of providing a series of M cross-sectional images, and the lights corresponding to each of the sequentially provided M cross-sectional images may be sequentially irradiated in the step of irradiating light.

In the step of irradiating light, the light corresponding to each of the M cross-sectional images may be irradiated with a same intensity and a same duration. Further, the light corresponding to each of the M cross-sectional images may be irradiated with a different intensity and a different duration.

In the step of providing a series of M cross-sectional images, a superimposed image produced by superimposing the M cross-sectional images one above another may be provided; and in the step of irradiating light, the light corresponding to the superimposed image may be irradiated into the photocurable resin.

In the step of irradiating light, the light is irradiated from pixels corresponding to the superimposed image, and the light from each pixel may have an intensity in proportional to the number of times the images are superimposed.

When a height of the photocurable resin for forming a cross-sectional layer provided in the step of providing a photocurable resin is L, the M cross-sectional images provided in the step of providing a series of M cross-sectional images may be cross-sectional images obtained by dividing the 3D object by a spacing of L/M.

Each of the M cross-sectional images may have a different boundary line positioned at different pixels each other or when all of the M cross-sectional images have a boundary line positioned at the same pixels, the boundary line of each of the images may have different color each other.

A three-dimensional (3D) printer control program according to an embodiment of the present invention may be a control program, which is stored in a medium to execute various steps of the method according to an embodiment of the present invention.

### Advantageous Effects

As described above, in the 3D printer, the 3D printing method and the 3D printer control program, according to an embodiment of the present invention, when forming a 3D object by laminating a plurality of cross-sectional layers, the surface resolution of the 3D object can be improved by more finely dividing one cross-sectional layer into a plurality of cross-sectional images and using the divided plurality of cross-sectional images to form the cross-sectional layer.

In addition, in the 3D printer, the 3D printing method and the 3D printer control program, according to an embodiment of the present invention, the surface resolution of the 3D object can be improved without increasing an output time until a object is completed

In addition, in the 3D printer, the 3D printing method and the 3D printer control program, according to an embodiment of the present invention, a cross-sectional layer having a smaller height than a minimum physical spacing of the 3D printer can be laminated, and the surface resolution of the 3D object can be improved without a need to replace or remodel the mechanical configuration of the 3D printer.

### BRIEF DESCRIPTION OF DRAWINGS

FIG. 1 shows surface roughness of a sculpture formed by a DLP type 3D printer.

FIG. 2 is a schematic view of a 3D printer according to an embodiment of the present invention.

FIG. 3 shows example cross-sectional images provided by an image providing unit and corresponding pixels of a light irradiation unit.

FIG. 4 comparatively shows a 3D object printed from a 3D printer according to an embodiment of the present invention and a 3D object printed from a conventional 3D printer.

FIG. 5 shows a flow diagram of a 3D printing method according to an embodiment of the present invention.

FIG. 6 shows a location of a moving unit for providing a photocurable resin for forming a first cross-sectional layer.

FIG. 7 shows a location of a moving unit for providing a photocurable resin for forming a second cross-sectional layer.

FIGS. 8 to 12 show examples of a plurality of cross-sectional images for forming a first cross-sectional layer, in which cross-sectional boundary lines are all positioned at different pixels.

FIG. 13 shows superimposed images produced by superimposing the cross-sectional images shown in FIGS. 8 to 12 one above another.

FIG. 14 shows an example of a first cross-sectional image of a second cross-sectional layer provided after the cross-sectional image shown in FIG. 12.

FIGS. 15 to 19 show examples of a plurality of cross-sectional images for forming a first cross-sectional layer, in which cross-sectional boundary lines are all positioned at the same pixel.

FIG. 20 shows superimposed images produced by superimposing the cross-sectional images shown in FIGS. 15 to 19 one above another.

FIG. 21 shows an example of a first cross-sectional image of a second cross-sectional layer provided after the cross-sectional image shown in FIG. 19.

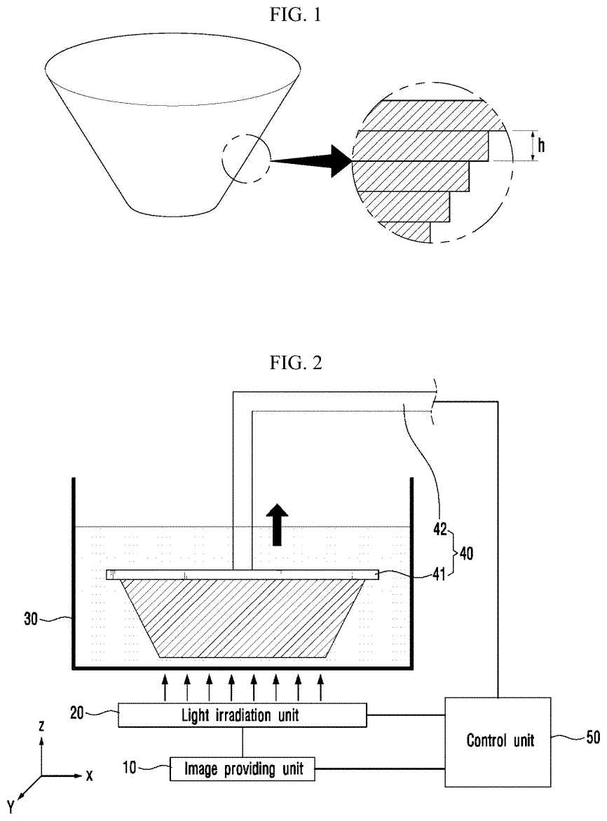

### BEST MODE FOR CARRYING OUT THE INVENTION

Hereinafter, a 3D printer, a 3D printing method and a 3D printer control program, according to an embodiment of the present invention, will be described in detail with reference to the accompanying drawings.

In the following description, only portions required for understanding the 3D printer, the 3D printing method and the 3D printer control program, according to the present invention, will be explained, descriptions of the other portions will be omitted so as not to obscure the gist of the present invention.

In addition, all terms or words used in the description and claims of the present disclosure that follow should not be construed as limiting to common meanings or meanings defined in the dictionary and should be construed as having meanings or concepts that are consistent with the technical spirit of the present invention so as to most suitably express the present invention.

In the present disclosure, it should be understood that when an element is referred to as “comprises” another element, unless there is another opposite description thereto, an element does not exclude another element but may further include the other element. In addition, the term “unit”, “device”, or “module” used herein may mean a unit for processing at least one function or operation, which can be implemented by hardware, software or a combination of hardware and software.

FIG. 2 is a schematic view of a 3D printer according to an embodiment of the present invention.

As shown in FIG. 2, the 3D printer according to an embodiment of the present invention includes an image providing unit 10, a light irradiation unit 20, a tank 30, a moving unit 40, and a control unit 50.

The image providing unit 10 provides cross-sectional images (x-y plane images in FIG. 2) of a 3D object to be formed using a 3D printer to the light irradiation unit 20.

The light irradiation unit 20 irradiates light beams (e.g., UV beams, electron beams, visible rays, etc.) corresponding to the images provided by the image providing unit 10.

The light irradiation unit 20, which is a device for irradiating the light beams corresponding to the images provided by the image providing unit 10, may include, for example, a light source and a digital micromirror device (DMD) capable of adjusting intensities of light beams supplied from the light source by each unit area (on a pixel by pixel basis).

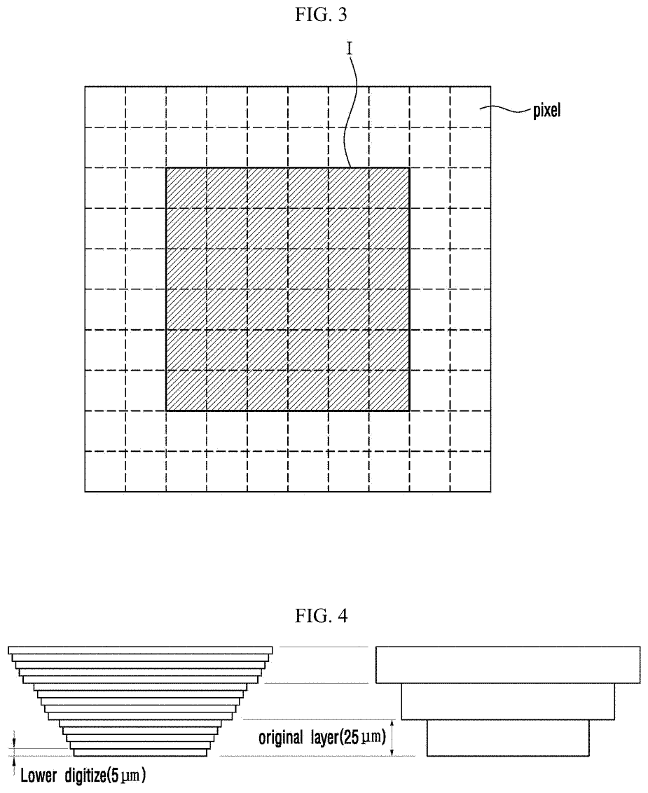

The DMD is a reflective display device including many micromirrors mounted on a semiconductor, and each of the micromirrors is movable at a predetermined angle. Therefore, as shown in FIG. 3, the micromirror of a pixel corresponding to an image I provided by the image providing unit 10 is rotated so as to irradiate the light beam supplied from the light source toward a tank to be described later, while the micromirrors of the remaining pixels are moveable so as not to irradiate the light beam supplied from the light source toward the tank. In addition, the micromirrors may move to allow some of the light beams from the light source to be irradiated toward the tank 30 and to allow some other light beams to be reflected according to the images provided by the image providing unit 10, thereby controlling the intensities of the light beams supplied to the tank on a pixel by pixel basis.

The tank 30 contains a photocurable resin that is cured by the light beams irradiated from the light irradiation unit 20.

As shown in FIG. 2, when the light beams irradiated from the light irradiation unit 20 are irradiated toward a bottom surface of the tank 30, the bottom surface of the tank 30 may be made of a light-transmitting material capable of transmitting the light beams from the light irradiation unit 20 to a photocurable resin.

The photocurable resin cured by the light beams from the light irradiation unit 20 is moved away from the light irradiation unit 20 by the moving unit 40 and is formed as a 3D object.

To this end, the moving unit 40 may include a plate 41 to which the cured photocurable resin is attached and a moving arm 42 moving the plate 41 away from or toward the light irradiation unit 20.

The control unit 50 controls operations of the image providing unit 10, the light irradiation unit 20 and the moving unit 40.

To form the 3D object using the 3D printer according to an embodiment of the present invention, in repeating a routine consisting of separating the plate 41 from the bottom surface of the tank 30 by a predetermined spacing distance L, followed by curing the photocurable resin by irradiating light beams to the photocurable resin, and then separating the plate 41 again, the control unit 50 may control the image providing unit to provide M cross-sectional images for the 3D object (M is an integer of 2 or greater), thereby improving the surface resolution of the 3D object.

Here, the provided cross-sectional images are cross-sectional images obtained by dividing the 3D object at a spacing smaller than the spacing distance L of the plate 41. For example, when the moving unit 40 moves the plate 41 as much as 25 μm at a time, the cross-sectional images are obtained by dividing the 3D image of the 3D object so as to have a thickness of less than 25 μm. Since the cross-sectional images are preferably divided to have a uniform thickness, they may be images obtained by dividing the 3D image of the 3D object so as to have a thickness of 5 μm when the image providing unit 10 provides five cross-sectional images (M=5).

Even when a cross-sectional layer is formed to have a height of 25 μm by the 3D printer according to an embodiment of the present invention, as shown in FIG. 4, the printed 3D object is similar to a 3D object in a case when a cross-sectional layer is formed to have a height of 5 μm (see the left drawing of FIG. 4). Therefore, when the cross-sectional layer is formed using several cross-sectional images, it can be seen that the surface resolution of the printed 3D object is improved than when the cross-sectional layer is formed using a single cross-sectional image (see the right drawing of FIG. 4).

A method of the control unit controlling the 3D printer according to an embodiment of the present invention will be described in more detail in describing the 3D printing method according to an embodiment of the present invention.

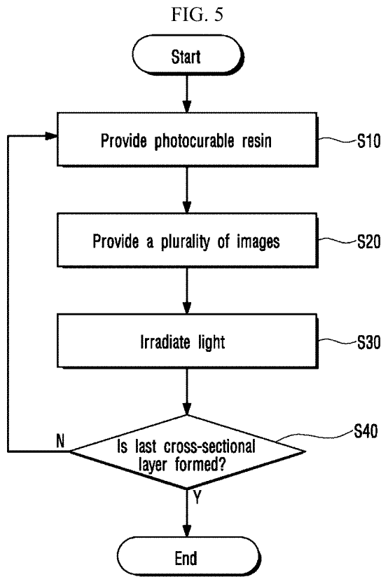

FIG. 5 shows a flow diagram of a 3D printing method according to an embodiment of the present invention.

As shown in FIG. 5, the 3D printing method according to an embodiment of the present invention is a method for forming a 3D object having cross-sectional layers laminated by repeating steps S10 to S30 for forming the cross-sectional layers.

That is to say, as the process consisting of a step of providing aphotocurable resin (S10), a step of providing a plurality of images (S20), and a step of irradiating light (S30) is performed once, one cross-sectional layer for the 3D object is completed. The 3D printing method according to an embodiment of the present invention completes the 3D object by iteratively performing the steps S10 to S30 for forming one cross-sectional layer until the last cross-sectional layer is formed.

The steps for forming a cross-sectional layer in the 3D printing method according to an embodiment of the present invention will now be described in more detail.

First, the step of providing a photocurable resin (S10) is a step of providing a liquid-phase photocurable resin to the plate 41 or to between a pre-formed cross-sectional layer and a light-irradiated plane to form a cross-sectional layer.

To this end, the control unit 50 controls the moving unit 40 to move the plate 41 to be spaced apart from the light-irradiated plane as much as the distance L corresponding to the thickness of one cross-sectional layer. Here, the light-irradiated plane means a plane of the photocurable resin, where the light beams from the light irradiation unit contact for the first time. In FIG. 2, the light-irradiated plane corresponds to the bottom surface of the tank 30.

In more detail, as shown in FIG. 2, the tank 30 of the 3D printer according to an embodiment of the present invention contains the photocurable resin for forming a 3D object.

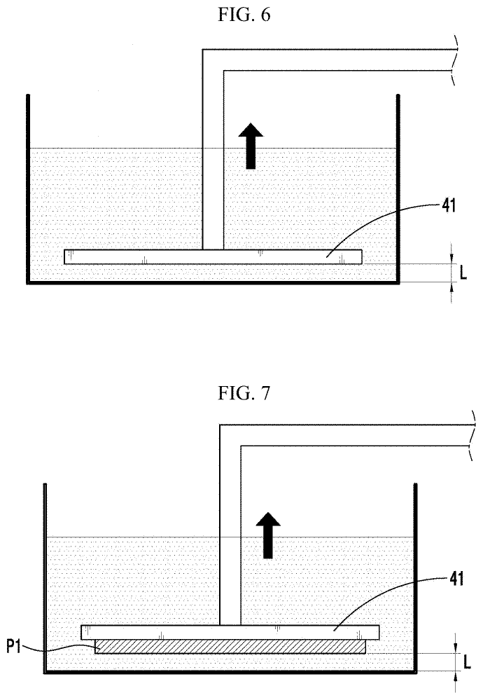

To provide the photocurable resin for forming a first cross-sectional layer, the control unit 50 controls the moving unit 40 to move the plate 41 to be spaced the distance L apart from the light-irradiated plane, the distance L corresponding to the thickness of one cross-sectional layer (see FIG. 6.).

In such a manner, if the plate 41 is positioned to be spaced the distance L apart from the tank bottom surface, the photocurable resin having the thickness L between the plate 41 and the tank bottom surface is provided as the photocurable resin for forming a first cross-section of the 3D object.

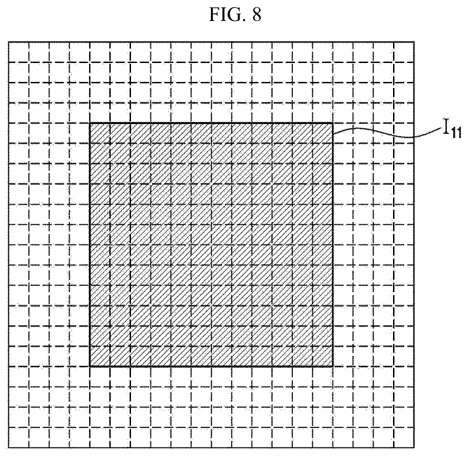

In addition, if a first cross-sectional plane P1 is formed through the step of providing a plurality of images (S20) and the step of irradiating light (S30), which will later be described, the control unit 50 controls the moving unit 40 to make the plate 41 spaced the distance L apart from the light-irradiated plane in the step of providing a photocurable resin of the next repeated process for forming a cross-sectional layer (see FIG. 7).

In this case, the first cross-sectional plane P1 attached to the plate 41 is spaced the distance L apart from the light-irradiated plane along with the plate 41, the photocurable resin having the thickness L between the first cross-sectional plane P1 and the tank bottom surface is provided as the photocurable resin for forming a second cross-sectional layer of the 3D object.

As described above, the control unit 50 controls the moving unit 40 to make the plate 41 further spaced the distance L apart from the light-irradiated plane in the step of providing a photocurable resin (S10) of the repeated process for forming a cross-sectional layer, thereby providing the photocurable resin for forming a next cross-sectional layer between the pre-formed cross-sectional layer and the light-irradiated plane.

Next, the step of providing a plurality of images (S20) is a step of providing a plurality of images for forming a cross-sectional layer to the light irradiation unit 20 by the image providing unit 10 of the 3D printer according to an embodiment of the present invention.

The control unit controls the image providing unit to provide a plurality of cross-sectional images for a 3D object to the light irradiation unit in the step of providing a plurality of images (S20).

Here, the plurality of cross-sectional images provided by the image providing unit include a series of cross-sectional images obtained by dividing a cross-sectional layer to be currently being formed at a smaller spacing.

That is to say, when forming the 3D object by laminating one cross-sectional layer having a thickness of 25 μm using the 3D printing method according to an embodiment of the present invention, the image providing unit may provide five cross-sectional images obtained by dividing the 3D object at a spacing of 5 μm for forming each cross-sectional layer in the step of providing a plurality of images.

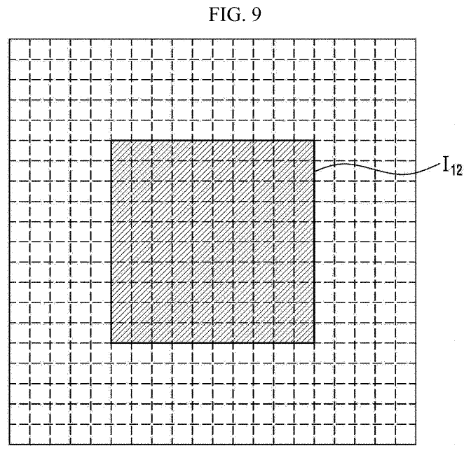

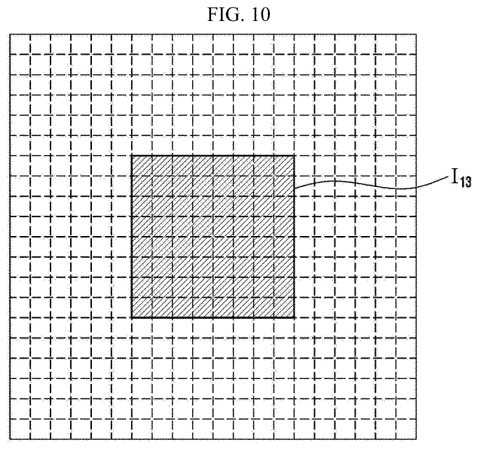

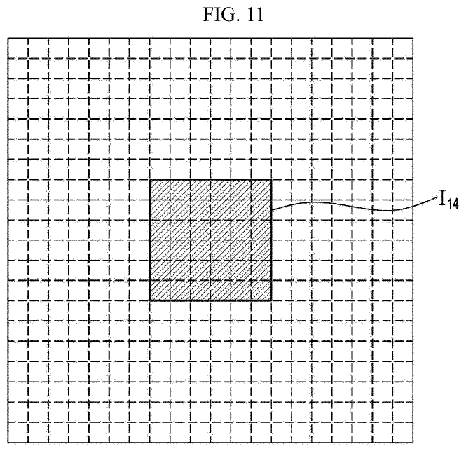

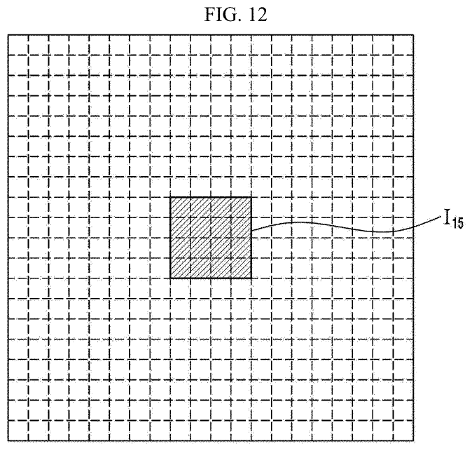

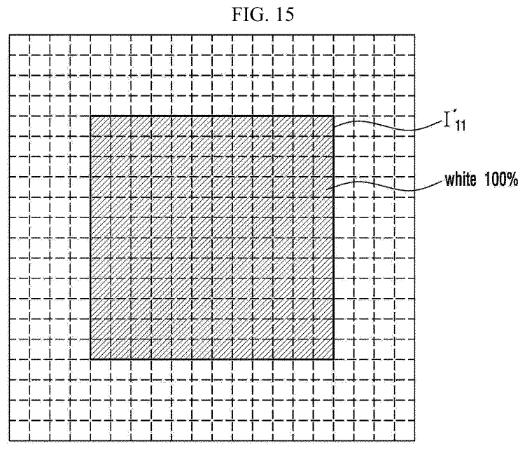

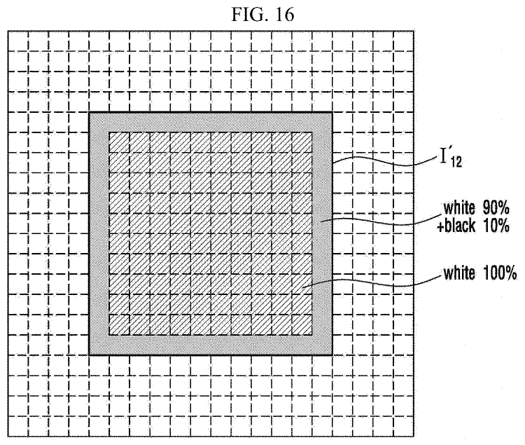

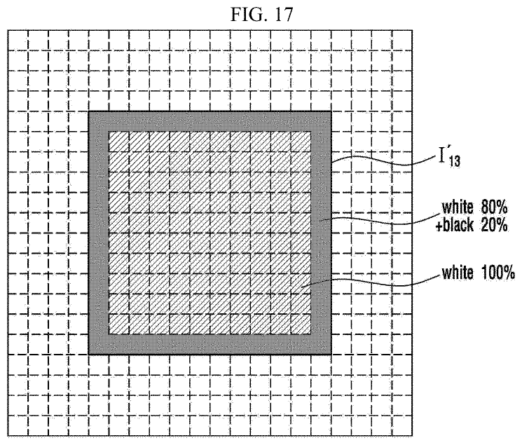

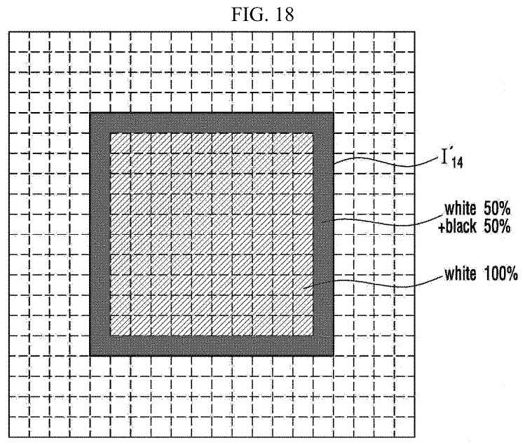

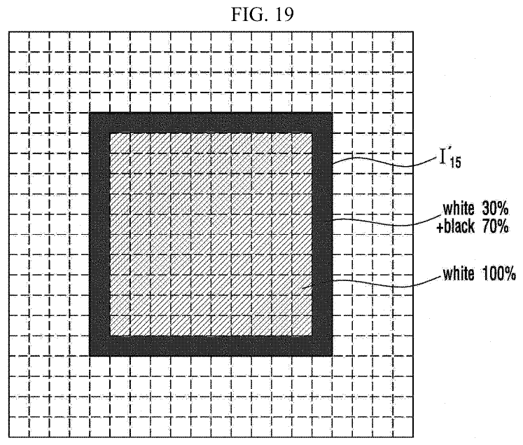

Here, the divided series of cross-sectional images may be images having boundary lines positioned at different pixels, as shown in FIGS. 8 to 12. Alternatively, the divided series of cross-sectional images may be images having boundary lines positioned at the same pixels while only the colors of the light irradiating on the boundary lines are different from one another, as shown in FIGS. 15 to 19.

The control unit may control the plurality of cross-sectional images to be sequentially provided to the light irradiation unit according to the direction in which the plurality of cross-sectional images are laminated or the control unit may control the superimposed images produced by superimposing the plurality of cross-sectional images one above another to be provided to the light irradiation unit.

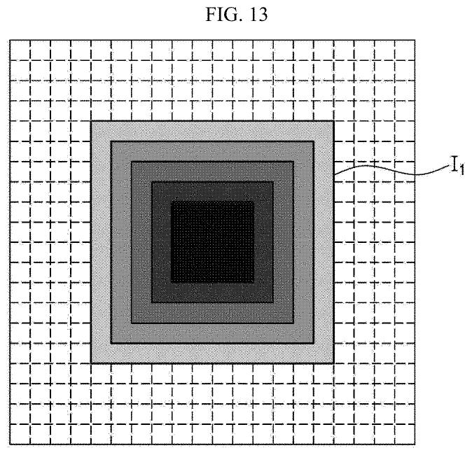

That is to say, the plurality of images I₁₁, I₁₂, I₁₃, I₁₄, and I₁₅ shown in FIGS. 8 to 12 may be controlled to be sequentially (i.e., I₁₁-I₁₂-I₁₃-I₁₄-I₁₅ in order) provided to the light irradiation unit or superimposed images (see FIG. 13) produced by superimposing the plurality of images I₁₁, I₁₂, I₁₃, I₁₄, and I₁₅ one above another may be controlled to be provided to the light irradiation unit.

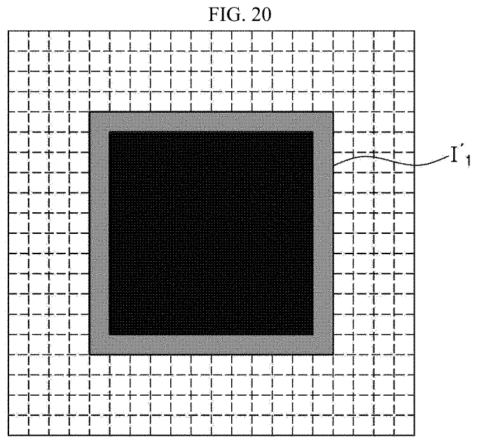

In addition, a plurality of images I′₁₁, I′₁₂, I′₁₃, I′₁₄, I′₁₅ shown in FIGS. 15 to 19 may be controlled to be sequentially (i.e., I′₁₁-I′₁₂-I′₁₃-I′₁₄-I′₁₅ in order) provided to the light irradiation unit or superimposed images (see FIG. 20) produced by superimposing the plurality of images I′₁₁, I′₁₂, I′₁₃, I′₁₄, and I′₁₅ one above another may be controlled to be provided to the light irradiation unit.

Superimposed images I₁ and I′₁ of a plurality of images may be images having various areas and each areas has different contrasts according to the number of the superimposed times, as shown in FIGS. 13 and 20. In FIGS. 13 and 20, as the more the images are superimposed, the areas of the images are displayed in darker colors. To the contrary, as the more images are superimposed, the areas of the images can be displayed in brighter colors.

In FIGS. 15 to 19, in order to represent changes in colors of pixels positioned at boundary lines (for example, changes in the white-black mixing ratios), the colors of the pixels are expressed to gradually darken. To the contrary, the colors of the pixels may be displayed to gradually brighten.

Next, the step of irradiating light (S30) is a step of curing the photocurable resin by irradiating the light beams corresponding to the plurality of cross-sectional images provided in the images providing step.

If the plurality of images I₁₁, I₁₂, I₁₃, I₁₄ and I₁₅ are sequentially (i.e., I₁₁-I₁₂-I₁₃-I₁₄-I₁₅ in order) provided to the light irradiation unit in the step of providing a plurality of images, the control unit may control the light irradiation unit to sequentially provide the light beams having the same intensity from the pixels of the light irradiation unit corresponding to the plurality of images to the photocurable resin. That is to say, assuming that the photocurable resin having a thickness L is cured by being exposed to the light having a luminous intensity X (e.g., 1000 lx) from the light irradiation unit for ten seconds, the control unit controls the light irradiation unit to irradiate the light having the luminous intensity X from the pixels corresponding to the image I₁₁ for two seconds, to irradiate the light having the luminous intensity X from the pixels corresponding to the next image I₁₂ for two seconds, to irradiate the light having the luminous intensity X from the pixels corresponding to the next image I₁₃ for two seconds, to irradiate the light having the luminous intensity X from the pixels corresponding to the next image I₁₄ and to irradiate the light having the luminous intensity X from the pixels corresponding to the next image I₁₅ for two seconds.

However, aspects of the present invention are not limited to irradiating the light beams having the same intensity for the same period of time. Rather, according to the present invention, light beams having different intensities corresponding to the respective images may be irradiated for different periods of time.

In addition, if a superimposed image I₁ of a plurality of images is provided to the light irradiation unit in the step of providing a plurality of images (S20), the light irradiation unit may irradiate light beams having different intensities according to contrasts of various areas of the superimposed image.

In detail, pixels of the light irradiation unit, corresponding to areas where five images are all superimposed, may be allowed to irradiate the light beams having the luminous intensity X for 10 seconds, pixels of the light irradiation unit, corresponding to areas where four images are superimposed, may be allowed to irradiate the light beams having luminous intensity 4X/5 for 10 seconds, pixels of the light irradiation unit, corresponding to areas where three images are superimposed, may be allowed to irradiate the light beams having luminous intensity 3X/5 for 10 seconds, pixels of the light irradiation unit, corresponding to areas where two images are superimposed, may be allowed to irradiate the light beams having luminous intensity 2X/5 for 10 seconds, and pixels of the light irradiation unit, corresponding to an area for only one image, may be allowed to irradiate the light beams having luminous intensity X/5 for 10 seconds. Alternatively, pixels of the light irradiation unit, corresponding to areas where five images are all superimposed, may be allowed to irradiate the light beams having the luminous intensity X for 10 seconds, pixels of the light irradiation unit, corresponding to areas where four images are superimposed, may be allowed to irradiate the light beams having the luminous intensity X for 8 seconds, pixels of the light irradiation unit, corresponding to areas where three images are superimposed, may be allowed to irradiate the light beams having luminous intensity X for 6 seconds, pixels of the light irradiation unit, corresponding to areas where two images are superimposed, may be allowed to irradiate the light beams having luminous intensity X for 4 seconds, and pixels of the light irradiation unit, corresponding to an area for only one image, may be allowed to irradiate the light beams having luminous intensity X for 2 seconds.

After the above-described process consisting of the step of providing a photocurable resin (S10), the step of providing a plurality of images (S20), and the step of irradiating light (S30) is performed, a cross-sectional layer having a thickness L is formed. Next, in the step S40, it is determined whether the formed cross-sectional layer is the last one or not. If not, the process returns to the step of providing a photocurable resin (S10) to form a next cross-sectional layer, and the step of providing a photocurable resin, the step of providing a plurality of images and the step of irradiating light for forming the next cross-sectional layers are iteratively performed.

If a 3D object is completed using 10,000 cross-sectional layers having a thickness L, the routine consisting of the step of providing a photocurable resin (S10), the step of providing a plurality of images (S20), and the step of irradiating light (S30) is repeatedly performed 10,000 times.

As described above, when a cross-sectional layer is formed using the 3D printer and 3D printing method, according to an embodiment of the present invention, edge portions that are not exposed to the light intensity high enough to be completely cured (hardened) may be attached to completely cured areas and form a smooth surface.

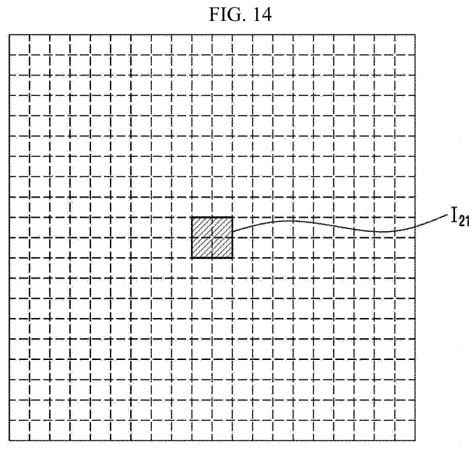

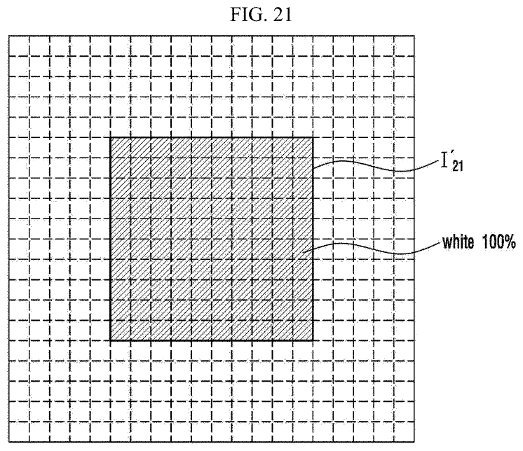

Therefore, according to the present invention, a distinctly staircase-like shape is not formed on the surface of a completed 3D object (see FIG. 4), unlike in the conventional method in which one cross-sectional plane P1 is formed using one image I₁₁ or I′₁₁ and then a next cross-sectional plane P2 is formed using another image I₂₁ or I′₂₁ shown in FIG. 14 or 21. Therefore, there is little demand for performing a postprocessing for smoothing the surface of the completed 3D object (e.g., a sandpapering process). At this stage, if the postprocessing is performed together with anti-aliasing, the surface resolution of the 3D object can be further improved.

In the conventional method in which one image is used for forming a cross-sectional layer, the surface resolution of a 3D object can be improved by more finely forming cross-sectional layers, that is, by dividing the cross-sectional layer to have a height of 5 μm, compared to the original layer having a height of 25 μm. However, since quite a long time is required in lifting a plate for forming a next cross-sectional layer after forming a previous one cross-sectional layer, the output time for completing a 3D object may be drastically increased with the height of the cross-sectional layer gradually decreasing.

However, in the 3D printer and 3D printing method according to an embodiment of the present invention, one cross-sectional layer to be formed is exposed using a series of cross-sectional images obtained by dividing the 3D object at a smaller spacing, rather than by dividing the cross-sectional layer so as to have a lower digitized height. Therefore, the surface resolution of the 3D object can be improved without increasing the output time. That is to say, there is little difference in the output time created between the conventional method in which a 3D object is formed using 10,000 images obtained by dividing a 3D object having a height of 25 cm at a spacing of 25 μm, and the method according to the present invention in which a 3D object is formed using 50, 000 images obtained by dividing a 3D object having a height of 25 cm at a spacing of 5 μm.

In addition, according to the conventional method, it is not possible to form a cross-sectional layer into a smaller unit than a minimum physical spacing of the 3D printer (that is, a minimum distance for accurately moving the plate 41). That is to say, a cross-sectional layer having a height of less than 10 μm cannot be formed when the minimum physical spacing is 10 μm.

However, according to the present invention, even when one cross-sectional layer has a height of 10 μm, a 3D object having improved surface resolution can be attained using a series of cross-sectional images obtained by dividing the 3D object at a spacing smaller than the height of the cross-sectional layer, like in a case where the 3D object is formed by laminating a cross-sectional layer having a height of less than 10 μm.

In addition, the 3D printer and 3D printing method according to an embodiment of the present invention can be achieved simply by changing a 3D printer control program without changing a physical configuration of the conventional 3D printer.

That is to say, the 3D printer and 3D printing method according to an embodiment of the present invention can be achieved simply by changing the conventional control program to a 3D printer control program stored in a medium to execute various steps of the 3D printing method according to an embodiment of the present invention in the 3D printer.

Although the foregoing embodiments have been described to practice the 3D printer, 3D printing method, and 3D printer control program of the present invention, these embodiments are set forth for illustrative purposes and do not serve to limit the invention. Those skilled in the art will readily appreciate that many modifications and variations can be made, without departing from the spirit and scope of the invention as defined in the appended claims, and such modifications and variations are encompassed within the scope and spirit of the present invention.

1. A three-dimensional (3D) printer comprising:
an image providing unit configured to provide a plurality of cross-sectional images for a 3D object;
a light irradiation unit configured to irradiate light corresponding to the plurality of cross-sectional images provided by the image providing unit;
a tank configured to contain a photocurable resin therein and receive the light from the light irradiation unit;
a moving unit configured to move the photocurable resin cured by means of the light by as much as a height of one cross-sectional layer; and
a control unit configured to control the image providing unit, the light irradiation unit and the moving unit,
wherein the control unit is configured to control the image providing unit to provide a series of M cross-sectional images for the 3D object between an Nth movement of the moving unit and a (N+1)th movement of the moving unit, where N is an integer of 0 or greater, and M is an integer of 2 or greater.

2. The 3D printer of claim 1, wherein when the displacement of the (N+1)th movement of the moving unit is L, the cross-sectional images are obtained by dividing the 3D object by a spacing of L/M.

3. The 3D printer of claim 2, wherein the control unit is configured to control the light irradiation unit such that pixels corresponding to each of the M cross-sectional images sequentially irradiate the light with a same intensity and a same duration.

4. The 3D printer of claim 2, wherein the control unit is configured to control the light irradiation unit such that pixels corresponding to each of the M cross-sectional images irradiate the light with a different intensity and a different duration.

5. The 3D printer of claim 2, wherein the image providing unit is configured to provide a superimposed image of the M cross-sectional images.

6. The 3D printer of claim 5, wherein the light irradiation unit is configured to irradiate the light from pixels into all areas of the superimposed image for the same period of time, and each pixel is configured to irradiate light with an intensity in proportional to the number of times the images are superimposed.

7. The 3D printer of claim 2, wherein each of the M cross-sectional images has a different boundary line positioned at different pixels each other; or when all of the M cross-sectional images have a same boundary line positioned at the same pixels, the boundary line of each of the images has different color each other.

8. A three-dimensional (3D) printing method for forming a 3D object by repeating a step of forming a cross-sectional layer,
wherein the step of forming a cross-sectional layer comprises:
a step of providing a photocurable resin to form a cross-sectional layer;
a step of providing a series of M cross-sectional images for the cross-sectional layer of the 3D object to a light irradiation unit, where M is an integer of 2 or greater; and
a step of irradiating light corresponding to each of the M cross-sectional images to the photocurable resin.

9. The 3D printing method of claim 8, wherein the M cross-sectional images are sequentially provided in the step of providing a series of M cross-sectional images, and the lights corresponding to each of the sequentially provided M cross-sectional images are sequentially irradiated in the step of irradiating light.

10. The 3D printing method of claim 9, wherein in the step of irradiating light, the light corresponding to each of the M cross-sectional images is irradiated with a same intensity and a same duration.

11. The 3D printing method of claim 9, wherein in the step of irradiating light, the light corresponding to each of the M cross-sectional images is irradiated with a different intensity and a different duration.

12. The 3D printing method of claim 8, wherein in the step of providing a series of M cross-sectional images, a superimposed image produced by superimposing the M cross-sectional images one above another is provided; and in the step of irradiating light, the light irradiation unit irradiates the light corresponding to the superimposed image to the photocurable resin.

13. The 3D printing method of claim 12, wherein in the step of irradiating light, the light is irradiated from pixels corresponding to the superimposed image, and the light from each pixel has an intensity in proportional to the number of times the images are superimposed.

14. The 3D printing method of claim 8, wherein when a height of the photocurable resin for forming a cross-sectional layer provided in the step of providing a photocurable resin is L, the M cross-sectional images provided in the step of providing a series of M cross-sectional images are cross-sectional images obtained by dividing the cross-section layer of the 3D object by a spacing of L/M.

15. The 3D printing method of claim 14, wherein each of the M cross-sectional images has a different boundary line positioned at different pixels each other or when all of the M cross-sectional images have a boundary line positioned at the same pixels, the boundary line of each of the images has different color each other.

16. A three-dimensional (3D) printer control program, which is stored in a medium to execute various steps of the method of claim 8 in a 3D printer.

17. A three-dimensional (3D) printer control program, which is stored in a medium to execute various steps of the method of claim 9 in a 3D printer.

18. A three-dimensional (3D) printer control program, which is stored in a medium to execute various steps of the method of claim 12 in a 3D printer.

19. A three-dimensional (3D) printer control program, which is stored in a medium to execute various steps of the method of claim 14 in a 3D printer.
